(19) United States
(12) Patent Application Publication
(10) Pub. No.: US 2026/0182763 A1
(43) Pub. Date: Jul. 2, 2026

(54) IMPROVED TUFTED CARPET SYSTEM FOR AUTOMOTIVE FLOORING

(71) Applicant: AUTONEUM MANAGEMENT AG, Winterthur (CH)

(72) Inventor: Giovanni LANGELLA, Zurich (CH)

(73) Assignee: AUTONEUM MANAGEMENT AG, Winterthur (CH)

(21) Appl. No.: 19/130,392

(22) PCT Filed: Nov. 23, 2023
(86) PCT No.: PCT/EP2023/082806

§ 371 Date: May 15, 2025

(30) Foreign Application Priority Data
Dec. 9, 2022 (EP) 22212599.9

(51) Int. Cl. A47G 27/02; D06N 7/00

(52) U.S. Cl. CPC A47G 27/0243; D06N 7/0065; D06N 7/0068; D06N 7/0081; D06N 2201/02; D06N 2211/066

(57) ABSTRACT

A tufted carpet system for a moulded automotive trim part or flooring comprising a nonwoven primary backing, a plurality of tufts comprising of bulk continuous filament (BCF) yarn, whereby the BCF yarn is inserted in the primary backing and projected on the opposite side of the insertion to form a tuft pile, a secondary backing layer and an adhesive between and in contact with the primary backing at the surface opposite the pile and the secondary backing.

### TECHNICAL FIELD

The invention is directed to a carpet system and a carpet floor construction for use in an automotive vehicle, like an engine driven car, a hybrid car or a battery electric vehicle.

### BACKGROUND ART

The floor in a car is covered by a multilayer carpet construction with an aesthetic surface formed by a carpet. The carpet itself is also a multilayer system. A tufted carpet system may comprise a primary backing fabric, a plurality of pile tufts comprising of bulk continuous filament (BCF) yarn. Whereby the BCF yarn, comprising of a plurality of filaments, is inserted by tufting through the primary backing fabric at a pre-determined gauge and cut to length to form the pile tufts. The tufts are inserted in the back of the primary backing and projecting on the opposite side of insertion in order to form the pile. Both the filaments within the tufts as well as the tufts in the primary backing need binding. Over the years different technologies are developed to obtain a good filament lock or binding within the tufted yarn as well as a good tuft lock or binding of the tufted yarn in the primary backing layer.

Abrasion testing of carpet surfaces show both the effect of abrasion on the filament lock-by showing the reduction of weight in the form of fiber loss after a certain amount of cycles with a grinding disk and the effect on filaments within the tufted yarn. By a low or failing tuft lock, open areas will appear in the tuft, and the primary backing layer becomes visible in a checked pattern. By a failing filament lock a high fiber loss can be observed, also resulting in the visible appearance of the primary backing layer through the pile. Normally abrasion testing is run until a certain amount of cycles is achieved or the backing becomes visible. So in cases where the backing becomes visible early in the test, the product fails.

To achieve good durability of a carpet surface, an good abrasion performance needs to be achieved. Many of the optimisation done in the past is there for dedicated at optimising the BCF yarn, or increasing the binding strength of the adhesive system used. For instance, combination of a primary backing layer a glue layer and a secondary backing layer covering the back of the tufts was used in the past to increase the tuft binding. It was tried to use primary backing layers including binder to further increase the tuft binding and filament locking.

For instance U.S. Pat. No. 5,532,035 discloses a polyethylene terephthalate (PET) based carpet construction with PET primary and secondary backing layers and PET tufted pile. The primary backing layer comprises additional low melting PET fibers that melt upon heating the carpet construction, binding the tufts within the primary backing upon cooling again, locking the tufts in place. While this may enable tuft lock, it lacks a strong filament binding or lock.

There is still a gap between the current tuft and filament binding systems used and the abrasion performance wanted by the customers.

The use of newer materials for fibers and the quest for obtaining a flooring construction that is based on mono material including any adhesives further request for new solutions. The use of one type of polymer for all layers and features poses a challenge as during different thermal steps the risk of degrading one while binding other layers is high. In particularly degrading the face material either by softening the filaments and therefor the tufts so they flatten and or lose the resilience or by backing material bleeding to the surface and smudging the pile.

Another problem of current carpet construction is the bending stiffness of the carpet system as part of carpet construction, as there is a trend to a lighter carpet construction the bending stiffness of the carpet construction defined as the pile layer until the secondary backing layer is becoming more important to achieve an overall stiff surface to step on.

In addition, the increased placement of electrical components underneath the carpet construction requires a robust system that is impermeable to water.

It is the objective of the current invention to provide for an alternative moulded carpet system having increased abrasion performance compared to current solution. In addition the carpet system and flooring construction may full fill all necessary requirements for a placement in a car. Furthermore a process is provided to produce such a carpet system.

### SUMMARY OF INVENTION

The object is obtained with a tufted carpet system for a moulded automotive trim part or flooring comprising a nonwoven primary backing, a plurality of tufts comprising of bulk continuous filament (BCF) yarn, whereby the BCF yarn is inserted in the primary backing and projected on the opposite side of the insertion to form a tuft pile, a secondary backing layer and an adhesive between and in contact with the primary backing at the surface opposite the pile and the secondary backing as claimed.

By the combination of the filaments of the BCF yarn having a tri-lobal cross section with a modification ratio of between 1.5 and 1.8, and the adhesive having a melt viscosity u of at least 100 PA·s at 150° C. and not more than 150 PA·s at 220° C., such that it at least locks the tufts and the filaments of the BCF yarn in the primary backing in the final trim part.

Surprisingly, lowering modification ratio of the tri-lobal filaments of the BCF yarn under 1.8, in combination with an adhesive that has a difference in melt viscosity over temperature, gives a good first distribution in the adhesive application phase while the higher melt viscosity in the second moulding phase prevents a too high redistribution into the yarn bundles. Creating an optimal final distribution and a balance between filament lock and tuft lock. It was found that by the combination of temperature and viscosity an increase in abrasion performance was measurable, with an increase in end cycle-meaning more abrasion cycles were possible before the backing became visible through the pile, and less fiber loss was measured. Even more surprisingly, this was not the case with all roll good materials tested before moulding. The increased abrasion performance became evident only after the moulding step.

Preferably the adhesive is a thermoplastic based adhesive. The adhesive may comprise at least a polymer or copolymer of polyester, preferably a terephthalate based polyester, preferably at least one of polyethylene terephthalate (PET), polybutylene terephthalate (PBT), polytrimethylene terephthalate (PTT) or any combination thereof. Preferably the adhesive has no or a low amount of inert fillers. The inert fillers might be one of minerals or polymers acting as inactive filler components, for instance in the form of fiber fragments as part of recycled material being mixed into the adhesive, before application. The adhesive may also have active components that are based on recycled content. For instance reclaimed or recycled polyester coming from automotive or postconsumer waste.

Preferably the adhesive has a density of between 0.9 and 1.2 kg/dm³. The adhesive applied on the back of the tufted primary backing layer may have an area weight of between 100 and 500 grams per m².

The adhesive used is preferably an thermally activated adhesive, a coating adhesive, or extruded adhesive comprising a polymer or a copolymer based on terephthalate based polyester, preferably a co-polyester with at least a terephthalate based polyester like for instance polybutylene terephthalate PBT or polyethylene terephthalate PET or a combination of two or more polyesters or co-polyesters.

BCF yarn is known in the industry and produced from multifilaments that are textured and tangled by airstream to form bulked yarn. A standard production process for a BCF yarn may contain the steps of melt spinning of a plurality of continuous filaments, extrusion of the plurality of continuous filaments; quenching of the extruded filaments; drawing of the quenched filaments; texturizing of the drawn filaments.

The BCF yarn used may be tangled by for instance an airstream to keep the filaments together. Proper tanglement increases the process stability and opening of the tufted yarn in the primary backing layer during the tufting process.

The BCF yarn according to the invention is spun through tri-lobal spinneret outlets forming a tri-lobal structure with a predefined modification ratio, although this might slightly change over the different drawing and cooling steps after the spin step. Preferably the BCF yarn comprises polyester based filaments, preferably terephthalate based polyester, preferably at least one of polyethylene terephthalate (PET), polybutylene terephthalate (PBT), polytrimethylene terephthalate (PTT), or including any combination thereof. The combination of these polyesters with the modification ratio of the filaments and the melt viscosity-temperature range of the adhesive further enhances the abrasion performance of the moulded carpet system, while maintaining a good resilience of the carpet pile during use.

Preferably the BCF yarn is produced with a recycled PET and or PBT. Preferably with an intrinsic viscocity of between 0.4 and 1.3, more preferably between 0.4 and 1.0

The BCF yarn may comprise between 40 to 300 filaments, preferably 60 to 210 filaments. The yarn may be tufted in any regular gauge used for automotive applications, preferably a gauge of 1/18, 1/10, 5/64 or 1/16 is used. Gauge refers to the number of surface pile yarns in one inch measured along the width of a tufted carpet. It is determined by spacing and number of needles per inch on the tufting machine and is expressed as a fraction.

To enable stretching of the primary backing during moulding in all direction a nonwoven primary backing layer is used. This may be a spunbond nonwoven. The spunbond nonwoven is preferably made of continuous bicomponent filaments that are laid and thermally bonded to form a web.

The spunbond nonwoven may alternatively comprise a mixture of continuous mono-component filaments and continuous bicomponent filaments.

Alternatively, the primary backing may comprise thermoplastic staple fibers and a thermoplastic binder.

Preferably also the primary backing layer comprises of polymers or copolymers of terephthalate based polyester.

The secondary backing layer may be one of a foam layer, felt layer, film layer, thermoplastic layer, or highly filled thermoplastic elastomeric layer adjacent the secondary backing layer. It may applied to the adhesive directly during the back coating stage or it may be applied during a second heating and moulding step. The choice for the secondary backing layer material is dependent on the use of any additional layers as well as the requirements, while a film or a foil layer may make the final automotive part impermeable to water, the use of a thicker felt layer may increase the overall perceived stiffness of the pile layer, when applying a force on the surface of the pile. This might be important on areas where passengers enter the vehicle and apply a force on the pile surface.

The tufted carpet system according to the invention may further comprise at least one or more additional layers preferably one of a foam layer, felt layer, film layer, thermoplastic layer, or highly filled thermoplastic elastomeric layer adjacent the secondary backing layer.

A tufted carpet system according to one of preceding claims, characterised in that the BCF yarn comprises 40 to 300 filaments, preferably 60 to 210 filaments.

A tufted carpet system according to one of the preceding claims characterised in that the diameter of the filament is preferably in the range of 1 to 20 decitex per filament preferably between 6 and 18.

Abrasion can be tested according to the DIN 53 754 (German Industrial Standard). The loss of weight does indicate the wear resistance or Taber abrasion after the test apparatus of Taber Industries. This procedure is a method for determining the wear resistance of trim materials by means of a rotary platform sample support and double abrasion wheel type machine. The wheels are pressed onto the pile layer of the sample while the rotation of the sample. After a certain number of revolutions of the sample its loss of fiber weight is measured, and the visual appearance is assessed. In particular a checkerboard appearance after abrasion testing points to a faulty tuft lock, while a high weight loss points to a bad filament lock.

The melt viscosity μ of the adhesive is measured according to ASTM D1238 (equivalent to ISO 1133). The measurement may be done for instance on a rheometer.

The fibers, filaments and/or yarns used may be based on bio-resourced, reclaimed, or recycled materials, or may include such type of sourced materials.

The Molecular weight of the BCF yarn may be measured with different measurements known in the industry for instance using Gel Permeation Chromatography (GPC).

Method of producing a moulded tufted carpet system according to one of the preceding claims, with at least the steps of
a. tufting a BCF yarn with tri-lobal filaments with a modification ratio of between 1.5 and 1.8 into a nonwoven primary backing;
b. applying an adhesive on the surface opposite the pile at a temperature of between 180 and 220° C., whereby the adhesive has a viscosity of not more than 150 PA·s at 220° C. and rapid cooling down the thus applied adhesive;
c. heating up the adhesive containing surface as well as the secondary backing layer, stack both materials in a mould, with the adhesive layer facing the secondary backing layer and moulding the final part, whereby the adhesive is having a melt viscosity of at least 100Pa·s at 150° C. such that the adhesive redistributes in the tufts and the filaments as well as the primary backing to enable tuft and filament locking.

Preferably the application of the adhesive is done by coating, preferably by roller coating or spray coating.

The method is further optimised when the adhesive comprises polymers or copolymers based on terephthalic based polyester, preferably polyethylene terephthalate PET or polybutylene terephthalate PBT or a mixture of terephthalate based polyesters, including at least one of PET or PBT.

Use of a tufted carpet system according to one of the preceding claims in a moulded trim part, preferably an inner dash part, a flooring part, a floor mat, a trunk cladding part, a door trim part, a front storage cladding part or a side panel trim part.

Preferably the carpet system or the automotive part including the carpet system produced comprises at least 95%, preferably 99%, polyester based components, such that the full part can be recycled in a polyester recycling process either mechanically and/or thermally and/or chemically.

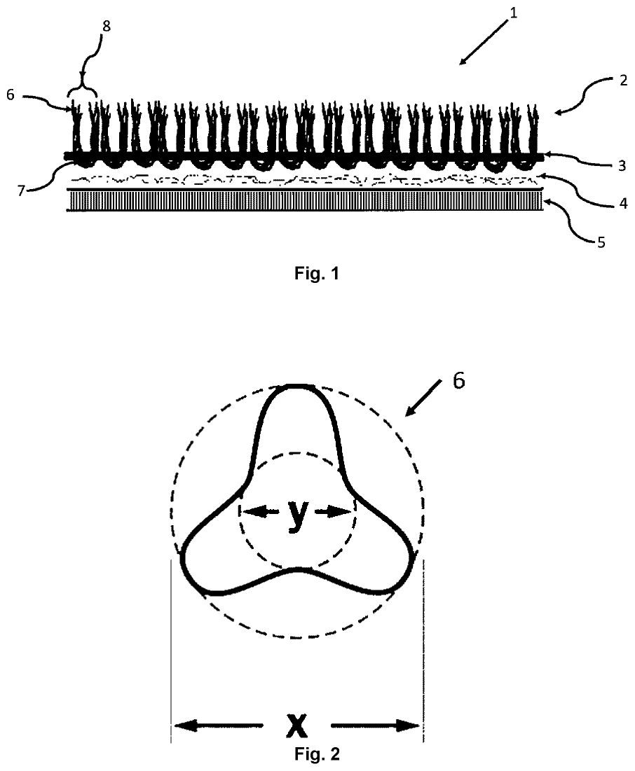

FIG. 1 is showing a tufted carpet system 1 according to the invention with a nonwoven primary backing 3 with a plurality of tufts 8 comprising of bulk continuous filament (BCF) yarn 6. The BCF yarn is inserted into the primary backing and projected on the opposite of insertion forming the tufts 8. At the back of the primary backing the thus inserted yarn forms loops 7. A multitude of tufts form together the carpet pile 2. The pile surface 2 is facing the passenger compartment and passengers might interact with it, hence the carpet surface should be aesthetically pleasing, without faults or streaks and have a good level of abrasion resistance and resilience.

A good abrasion resistance is dependent on filament lock and tuft lock. Filament lock is defined as the pull out of filaments 6 from the bundle forming a tuft 8. Tuft lock is the pull out of a full tuft at once. Both are dependent on the adhesion 4 used on the back of the primary backing.

However, a tufted carpet system used on a carpet flooring part or trim part in an automotive vehicle is moulded in a required 3-dimensional shape, whereby the adhesive gets heated and redistributed again, while the primary backing and all other layers are stretched and formed. A perfect result in a flat roll material might end up being ruined by the moulding step.

Surprisingly, it was found that the combination of the modification ratio of the BCF yarn and the melt viscosity of the adhesive optimised over a temperature range, enables a first application, and a redistribution such that the tuft and filament lock is in a preferred balance. Resulting in an overall increased abrasion performance without tuft pull out, an increase end cycle at abrasion testing and a reduced fiber loss.

The adhesive according to the invention might be applied to the back of the tufted primary backing and covered with a secondary backing layer. This might be a nonwoven layer, a film or a felt layer. For instance, a felt layer comprising staple fibers based on polyester, preferably a carded, cross-lapped and needled felt and/or an air lay felt with or without needling may be used. The felt layer may comprise a binder preferably a polypropylene PP or polyester based binder, for instance in the form of binder fibers or combined as bicomponent binder fibers whereby one component has a lower melting temperature and melts and binds the surrounding fibers during moulding of the part. Preferably the felt layer is based on polyester fibers only, eventually combined with bicomponent core sheath binder fibers whereby the sheath is a low melting polyester forming the binding component.

The choice of the secondary layer may be depended on additional layers used underneath the carpet system (not shown). Additional layers used may be at least one of a foam layer, felt layer, a thermoplastic layer, like a film or a filled thermoplastic elastomeric layer, or combination of such layers.

For example the carpet system might be placed on top or be laminated to an insulating mass spring system with a mass layer (also called heavy layer) normally formed of an extruded blank of highly filled thermoplastic material and a soft decoupling layer made of either a foam or a felt material.

An example of a carpet system according to the invention is recycled PET based filament 1200/144 dtex BCF yarn tufted into a polyester spunbond primary backing layer with an area weight of 120 gsm. A polyester based adhesive is coated to the back of the tufted primary backing and a secondary backing layer is placed and bonded to the adhesive. As a secondary backing a 450 gsm fibrous layer is used, for instance a shoddy cotton material, preferably needled, with at least 70% recycled fibers and up to 30% of a binder, for instance a bicomponent fiber. The shoddy material is normally a mixture of fibers whereby the shoddy is defined by the material of the bulk of the shoddy material, hence a cotton shoddy has more than 50% of cotton material but may comprise other fibers like for instance and preferred polyester based material.

Alternatively, the shoddy material may be a shoddy polyester felt, preferably needled, based on polyester containing waste chips, textiles and a polyester binder. Preferably a 100% polyester based shoddy material is used.

FIG. 2 is showing a cross section of a preferred tri-lobal filament 6 forming the basis for the BCF yarn. The modification ratio is the ratio between the outer circle X and the inner circle Y as indicated in the figure.

A high modification ratio would indicate a tri-lobal structure with long thinned arms, while a low modification ratio would indicate a tri-lobal structure going into the direction of a triangle shape. The shape of the BCF yarn has been optimised in the past related to the appearance and resilience of the carpet pile. Surprisingly the modification ratio has also a direct impact on the distribution and even more important redistribution of the adhesive used to obtain a tuft and filament lock.

The modification ratio of the filament is known to optimise the visual appearance of the tuft in the final carpet, in the sense of lustre and resilience of the tufts above the bonded region. Surprisingly, the modification ratio has an impact on the actual fiber and tuft lock results.

While it is thought that a higher modification ratio should be chosen, actually a lower modification ratio under 1.8 performs better in abrasion testing. By increasing the modification ratio above 1.8 with the same melt viscosity the filament lock increased, but at the cost of tuft locking. It could even be observed that during abrasion tests already in an early stage full tufts were pulled out of the surface, while the amount of fiber loss overall was low, rendering in holes in the overall tufted surface. Preferably a modification ration of 1.5 to 1.8 is used for the BCF filament yarn.

At a lower modification ratio the balance between filament lock and tuft lock was enhanced. While the reduction of the melt viscosity showed an increased filament lock but at the expense of the tuft lock, while an increase of viscosity increases tuft lock, but reduces filament lock.

Surprisingly a modification ratio under 1.8, and an adhesive with melt viscosity of at least 100Pa·s. at 150° C. and a melt viscosity of not more than 150Pa·s at 220° C., would show an optimal balance between tuft lock and filament lock while maintaining a good surface aspect even after thermal moulding of the final part.

The effect may be further improved by using a polyester based BCF yarn, preferably a BCF yarn based on a terephthalate based polyester, for instance a BCF yarn made of polyethylene terephthalate (PET), polybutylene terephthalate (PBT), Polytrimethylene terephthalate (PTT) or a combination of terephthalate based polyesters.

The thus formed carpet system might be placed on top or is laminated to an insulating mass spring system with a mass layer (also called heavy layer) (7) normally formed of an extruded blank of highly filled thermoplastic material and a soft decoupling layer (8) made of either a foam or a felt material.

1. A tufted carpet system for a molded automotive trim part or flooring, comprising:
a nonwoven primary backing;
a plurality of tufts comprised of bulk continuous filament (BCF) yarn, whereby the BCF yarn is inserted in the primary backing and project on the opposite side of insertion points to form a tuft pile;
a secondary backing layer;
an adhesive between and in contact with the primary backing at a surface opposite the pile and the secondary backing; and
wherein filaments of the BCF yarn have a tri-lobal cross section with a modification ratio of between 1.5 and 1.8, and wherein the adhesive has a melt viscosity μ of at least 100 PA·s at 150° C. and less than 150 PA·s at 220° C., such that it at least locks the tufts and the filament of the BCF yarn in the primary backing.

2. The tufted carpet system according to claim 1, wherein the adhesive has a density of between 0.9 and 1.2kg/dm³.

3. The tufted carpet system according to claim 1, wherein the area weight of the adhesive is between 100 and 500 grams per m².

4. The tufted carpet system according to claim 1, wherein the adhesive comprises at least a polymer or copolymer of polyester, preferably a terephthalate based polyester.

5. The tufted carpet system according to claim 1, further comprising at least one of a foam layer, felt layer, film layer, thermoplastic layer, or highly filled thermoplastic elastomeric layer adjacent the secondary backing layer.

6. The tufted carpet system according to claim 1, wherein the BCF yarn comprises polyester based filaments.

7. The tufted carpet according to claim 1, wherein the filaments of the BCF yarn comprises recycled polyethylene terephthalate with a molecular weight <50.000 g/mol, a modification ratio of between 1.65 and 1.78, and an IV of between 0.4 and 0.9.

8. The tufted carpet system according to claim 1, wherein the primary backing comprises continuous filaments and a binder component.

9. The tufted carpet system according to claim 1, whereby the secondary backing layer is a foam layer, felt layer, film layer, thermoplastic layer, or highly filled thermoplastic elastomeric layer.

10. The tufted carpet system according to claim 1, wherein the BCF yarn comprises 40 to 300 filaments.

11. The tufted carpet system according to claim 1, wherein the diameter of the filament is in the range of 1 to 20 decitex per filament.

12. A method of producing a molded tufted carpet system comprising:
tufting a BCF yarn with tri-lobal filaments with a modification ratio of between 1.5 and 1.8 into a nonwoven primary backing;
applying an adhesive on a surface opposite tufted BCF yarn pile at a temperature of between 180 and 220° C., whereby the adhesive has a viscosity of not more than 150 PA·s at 220° C.;
rapid cooling the applied adhesive to form an adhesive layer;
heating the adhesive containing surface a secondary backing layer;
stacking the adhesive and the secondary backing in a mold, with the adhesive layer facing the secondary backing layer; and
mounding a final part, whereby the adhesive has a melt viscosity of at least 100 Pa·s at 150° C., such that the adhesive redistributes in the tufted BCF yarn and the filaments and the primary backing to lock the tufted BCF yarn and filaments.

13. The method according to claim 12, whereby the adhesive is applied by coating.

14. The method of claim 12, whereby the adhesive comprises polymers or copolymers based on terephthalic based polyester.

15. A method of using a tufted carpet system according to claim 1 in molded trim part.

16. The tufted carpet system according to claim 6, wherein the polyester based filaments are comprised of terephthalate based polyester.

17. The tufted carpet system according to claim 8, wherein the continuous filaments comprise at least one of continuous bicomponent filaments or staple fibers with at least one component with a lower melting temperature to act as the binder.

18. The method of claim 14, wherein the terephthalic based polyester, is polyethylene terephthalate PET, polybutylene terephthalate PBT, or a mixture of terephthalate based polyesters, including at least one of PET or PBT.
